(19) United States
(12) Patent Application Publication
(10) Pub. No.: US 2023/0316102 A1
(43) Pub. Date: Oct. 5, 2023

(54) INTEGRATION AND USE OF SPARSE HIERARCHICAL TRAINING DATA

(71) Applicant: SAP SE, Walldorf (DE)

(72) Inventors: James ODENDAL, Munich (DE); Maximilian STUEBER, Mannheim (DE); Pascal KUGLER, Wiesloch (DE); Ravi MEHTA, Bangalore (IN); Mathis BOERNER, Bielefeld (DE); Michael HETTICH, Heidelberg (DE); Gregor Karl FREY, Lorsch (DE)

(21) Appl. No.: 17/713,000

(22) Filed: Apr. 4, 2022

(51) Int. Cl. G06N 5/02

(52) U.S. Cl. CPC G06N 5/022

(57) ABSTRACT

Systems and methods include determination of a plurality of instances of a master configuration file, association of each of the plurality of instances with a first respective record of a first database table and with a second respective record of a second database table to determine a plurality of composite data records, determination of correlated features of the master configuration file, the first database table and the second database table based on the plurality of composite data records, and training of a machine learning model based on data of the correlated features of the master configuration file, the first database table and the second database table.

### BACKGROUND

Modern computing system landscapes store vast amounts of data. Applications and other logic may access this stored data in order to perform various functions thereon. Functions may include estimation or forecasting of data values based on stored data. Such estimation, forecasting and other functions are increasingly provided by trained neural networks, or models.

A model may be trained to infer a value of a target (e.g., a delivery date) based on a set of inputs (e.g., fields of a sales order). The training may be based on historical data (e.g., a large number of sales orders and their respective delivery dates) and results in a trained model which represents patterns in the historical data. The trained model may be used to infer a target value for which it was trained (e.g., a delivery date) based on new input data (e.g., fields of a new sales order).

In order for the foregoing approach to be effective and efficient, the historical data should exhibit certain characteristics. For example, the historical data should be encapsulated into individual instances or records, with each field of each record including associated data. Each record should consist of a suitable number of fields to provide the training algorithm with an appropriate level of dimensionality, and the fields should be densely populated with data values (i.e., not sparse).

The above-described characteristics are not present in many scenarios. For example, many conventional system landscapes store data in silos which are independently operated upon by dedicated applications. This siloing prevents the generation of records which include data that is stored in different silos but which is nonetheless related.

In other examples, a data schema may be intended to capture many different scenarios/configurations, in which case a single instance of the schema may comprise an extremely sparse data structure. Using such instances as historical training data would likely result in a large, inaccurate, and otherwise inefficient model.

Systems are desired to integrate and use sparse and/or uncorrelated data for the training of machine learning models.

### BRIEF DESCRIPTION OF THE DRAWINGS

FIG. 1 is a block diagram of a computing system landscape for training machine learning algorithms based on disparate data according to some embodiments.

FIG. 2 is an illustrative representation of the structure of a master configuration file according to some embodiments.

FIG. 3 is a view of a user interface to receive a product configuration according to some embodiments.

FIG. 4 is a view of a user interface to receive a product configuration according to some embodiments.

FIG. 5 is a view of a user interface to receive a product configuration according to some embodiments.

FIG. 6 is an illustrative representation of an instance of a master configuration file according to some embodiments.

FIG. 7 is an illustrative representation of an instance of a master configuration file according to some embodiments.

FIG. 8 is an illustrative representation of an instance of a master configuration file according to some embodiments.

FIG. 9 is a block diagram of an architecture to generate a machine learning algorithm based on disparate data according to some embodiments.

FIG. 10 comprises a flow diagram to generate a machine learning algorithm based on disparate data according to some embodiments.

FIG. 11 is a tabular representation of associated fields of various data records according to some embodiments.

FIG. 12 is a tabular representation of correlated and encoded fields across various data records according to some embodiments.

FIG. 13 is a block diagram of an architecture to use a clustering algorithm trained according to some embodiments.

FIG. 14 is a block diagram of an architecture to use a regression algorithm trained according to some embodiments.

FIG. 15 is a block diagram of an architecture to use a classification algorithm trained according to some embodiments.

FIG. 16 is a block diagram of a cloud-based system according to some embodiments.

### DETAILED DESCRIPTION

The following description is provided to enable any person in the art to make and use the described embodiments. Various modifications, however, will be readily apparent to those in the art.

According to some embodiments, a plurality of sparse instances of a master object (e.g., a configuration file) are determined. Each of the instances is associated with a respective instance of one or more other objects (e.g., a purchase/sales order object and a customer object). Next, features of the respective objects which are correlated with one another are determined based on the data of the instances. A machine learning model is trained based on the determined features and the respective data thereof. The trained machine learning model may be operable, for example, to determine clusters associated with input data, to determine a value (e.g., price) based on input data, or to determine a classification based on input data.

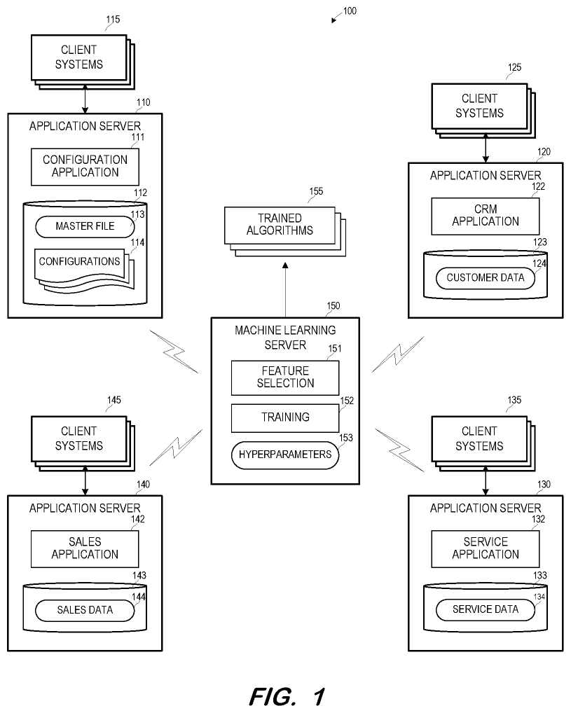

FIG. 1 is a block diagram of architecture 100 according to some embodiments. The illustrated elements of architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of architecture 100 are implemented by a single computing device, and/or two or more elements of architecture 100 are co-located. One or more elements of architecture 100 may be implemented using cloud-based resources, and/or other systems which apportion computing resources elastically according to demand, need, price, and/or any other metric.

Application server 110 may provide functionality to client systems 115. Application server 110 executes configuration application 111 which may, for example, provide user interfaces to client systems 115 via Web pages in response to commands received from Web browsers executing on client systems 115. Embodiments are not limited thereto, as client systems 115 may execute dedicated front-end client applications for accessing the functionality provided by application server 110.

Configuration application 111 may operate to facilitate definition of a product configuration. Configuration application 111 may comprise a component of a product lifecycle manager application, but embodiments are not limited thereto. According to some embodiments, configuration application 111 utilizes master file 113 stored in data storage 112 to generate configurations 114. Configurations 114 may comprise instances of master file 113 as will be described in more detail below. Storage 112 may comprise any standalone or distributed storage system that is or becomes known, including but not limited to a database system which is separate from the hardware implementing application server 110.

Application servers 120, 130 and 140 each execute a respective application 122, 132 and 142 to provide functionality to respective client systems 125, 135 and 145. Customer Relationship Management (CRM) application 122 may be accessed by client systems 125 to generate, modify or delete customer data 124 stored in data storage 123. Customer data 124 may comprise data identifying a customer (e.g., customer ID, social security number, birthday, name, address) as well as any other information suitable to CRM application 122. Such customers may include one or more users associated with a configuration 114 (e.g., a user who operated configuration application 111 to generate a configuration 114).

Service application 132 of application server 130 may be accessed by client systems 135 to manage and document service events associated with a product. Related data (e.g., date, affected product components, description of problem, description of resolution) is stored in service data 134 of data storage 133. Such data may identify the product type (e.g., model) and specific instance (e.g., product identification number) with which a particular service event is associated. The specific instance may be associated with one of configurations 114 and/or with a customer specified in customer data 124.

Application server 140 executes sales application 142 to provide client systems 145 with sales-related functionality, such as but not limited to price calculation, purchase order generation, and payment processing. Data generated by sales application 142 is stored among sales data 144 of data storage 143. Sales data 144 may identify a specific instance of a product as well as a customer associated with a specific instance. As will be described below, this information may be used to identify a configuration 114 as well as records of service data 134 and customer data 124 which are associated with a particular record of sales data 144.

Although application servers 110-140 are depicted as separate entities, some implementations may execute two or more of applications 111, 122, 132 and 142 within a single application server. Moreover, two or more of client systems 115, 125, 135 and 145 may include one or more common client systems. That is, a single client system/user may access two or more of applications 111, 122, 132 and 142 such that applications 111, 122, 132 and 142 are not limited to access by a dedicated group of client systems/users.

Machine learning server 150 is in communication with each of application servers 110-140 and may receive stored data records therefrom. As will be described below, machine learning server 150 may associate data records received from different servers, for example based on customer identifiers, product identifiers, etc. Machine learning server 150 may execute feature selection 151 to determine correlated fields based on the related records.

Training component 152 of machine learning server 150 operates to train a machine learning model based on the selected features to generate a trained algorithm 155. Hyperparameters 153 define the structures of such machine learning models as is known in the art. A trained algorithm 155 may comprise a clustering, regression, classification and/or other algorithm depending on the type of model utilized. Training component 152 may utilize any suitable training techniques that are or become known, including but not limited to Support Vector Machine (SMV), Linear Regression, Logistic Regression, Decision Tree Learning and K-Nearest Neighbors.

Machine learning server 150 may comprise any combination of on-premise and cloud-based servers. Functions attributed thereto may be performed by more than one machine learning server. In one example, feature selection may be performed by a first server, training by a second server, and inference using trained algorithms by a third server.

Trained algorithms 155 may be used by any suitable system to generate an associated inference. For example, a new configuration may be input into a trained algorithm 155 to infer a corresponding price. In another example, various fields of a new product configuration may be input to a trained algorithm 155 along with required input fields of corresponding records of customer data 124 and sales data 144 to infer a cluster, which may then be used to determine follow-up service and/or promotional actions.

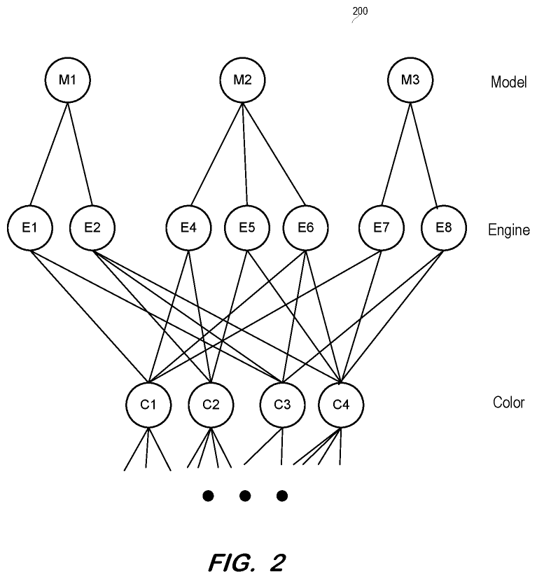

FIG. 2 is an illustrative representation of the structure of a master configuration file 200 according to some embodiments. Embodiments are not limited to the FIG. 2 structure or to any tree structure of linked nodes.

Master configuration file 200 may be used by a configuration application to request and define a configuration of a vehicle, but embodiments are not limited thereto. File 200 includes various node levels, beginning with Model nodes at the root level and having Engine and Color nodes at the child and grandchild levels. File 200 may include additional level.

The nodes of a particular level are shown connected to one or more nodes of a next level. The connections determine which nodes can be reached (i.e., selected) from a particular node. For example, selection of node M3 limits the choice of Engine-level nodes to E7 and E8, from which only Color-level nodes C1 and C4 (from node E7) or C3 and C4 (from node E8) can be reached. Embodiments are not limited to this behavior.

FIG. 3 is a view of a user interface to receive a product configuration according to some embodiments. According to some embodiments, a user operates a client system 115 to access configuration application 111. For example, the user may operate a client system 115 to execute a Web browser and to input a Uniform Resource Locator (URL) associated with a domain of configuration application 115. The Web Browser issues a request based on the URL and receives user interface (i.e., Web page) 300 in return.

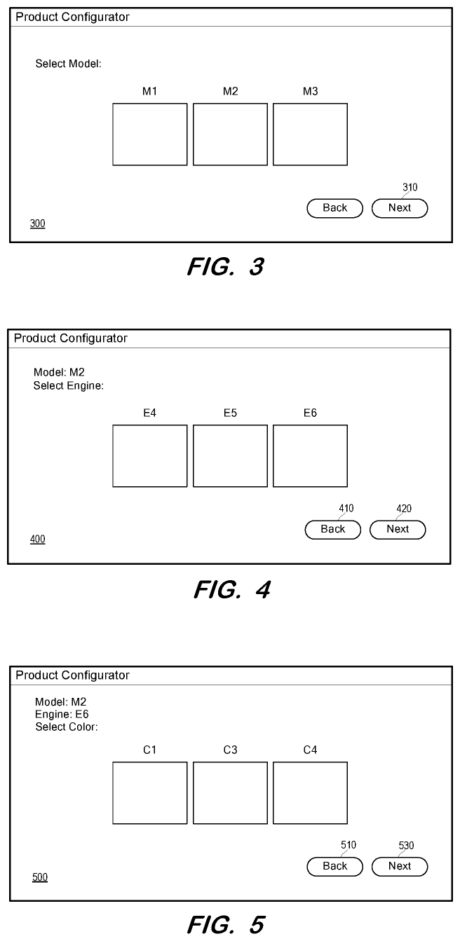

According to the present example, the product configuration presented in the user interfaces of FIG. 3-5 is based on file 200 of FIG. 2. Accordingly, user interface 300 requests selection of a model of the product and presents model options corresponding to root-level nodes M1, M2 and M3 of file 200. It will be assumed that the user selects option M2 and Next control 310. User interface 400 of FIG. 4 is presented in response.

Referring to file 200, selected node M2 is connected to nodes E4, E5 and E6 of the Engine-level nodes. Accordingly, user interface 400 shows only options corresponding to nodes E4, E5 and E6. The user may select Back control 410 in order to change the Model selection and therefore be presented with a different set of Engine options within user interface 400. It will be assumed for purposes of the present example that the user selects Engine option E6 and Next control 420.

Selected node E6 is connected to nodes C1, C3 and C4 in file 200. User interface 500 therefore shows options corresponding to nodes C1, C3 and C4. Again, the user may select Back control 510 in order to change the existing Engine or Model selection and therefore be presented with a different set of Color options within user interface 400. It will be assumed for purposes of the present example that the user selects Color option E6 and Next control 520. The process may continue in this manner through any remaining levels of file 200.

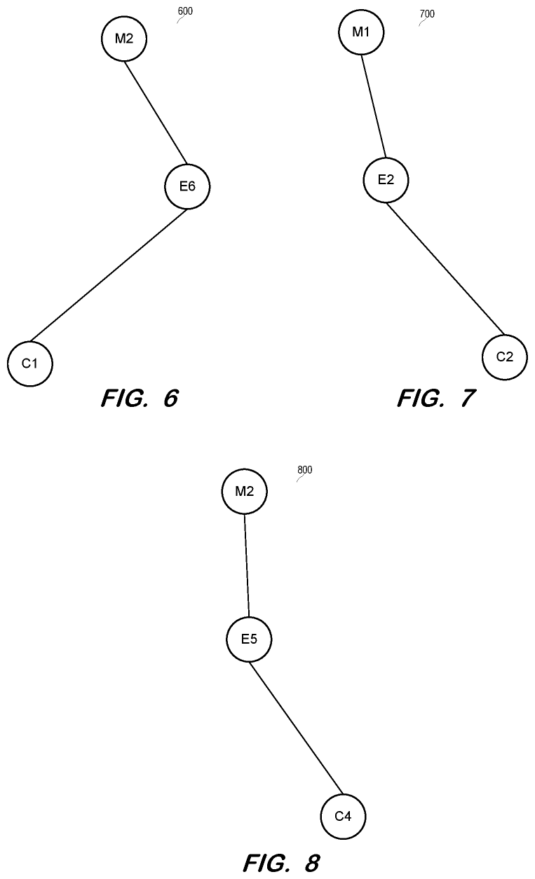

FIG. 6 is an illustrative representation of an instance of master configuration file 200 according to the above example. Instance 600 includes only the nodes which were selected as described above, i.e., nodes M2, E6 and C1. As shown, instance 600 is a sparse version of file 200 and includes much less data than file 200. FIG. 7 illustrates instance 700 of another product configuration based on file 200. The nodes of instance 700 conform to the dependencies of file 200, as do the nodes of instance 800, which is yet another product configuration based on file 200.

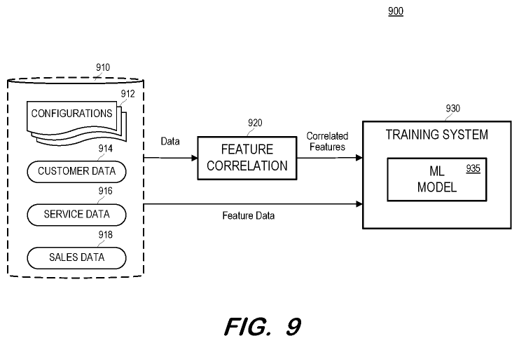

FIG. 9 is a block diagram of architecture 900 to generate a machine learning algorithm based on disparate data according to some embodiments. FIG. 9 includes data 910 which may be obtained from any number or type of sources. As shown, data 910 includes data similar to that shown in FIG. 1 and therefore may be generated by the applications described therein. In particular, data 910 includes configurations 912, customer data 914, service data 916 and sales data 918. Embodiments are not limited thereto.

Feature correlation component 920 determines correlated features based on data 910. For example, feature correlation component 920 may generate composite records by joining records of configurations 912, customer data 914, service data 916 and sales data 918 along common columns (e.g., product instance, customer id, etc.). Each column of the composite records is considered a feature, and feature correlation component 920 may operate to determine degrees to which each feature is correlated with each other features based on the data of the composite records as is known in the art.

The determined degrees are used to determine correlated features to output to training system 930. In one example, one feature (e.g., price) is to be a target of a regression algorithm. Accordingly, the determined correlated features are those which are most correlated to the price feature and therefore provide the most-relevant information needed for accurate inference of a price. In another example, one feature (e.g., gender) is to be a target of a classification algorithm. The correlated features determined for this example are those which, based on training data 910, would be most useful in accurately inferring the classification of the target feature.

Training system 930 receives the correlated features and is initialized with machine learning model 935. Model 935 may comprise any type of learning model that is or becomes known. Broadly, model 935 may comprise a network of neurons which receive input, change internal state according to that input, and produce output depending on the input and internal state. The output of certain neurons is connected to the input of other neurons to form a directed and weighted graph. The weights as well as the functions that compute the internal state can be modified via training as will be described below. Model 935 may comprise any one or more types of artificial neural network that are or become known, including but not limited to convolutional neural networks, recurrent neural networks, long short-term memory networks, deep reservoir computing and deep echo state networks, deep belief networks, and deep stacking networks.

Training system 920 trains model 935 to implement an algorithm. The training is based on data of data 910 which corresponds to the determined correlated features. The data of a given feature may be encoded into numeric data if not already in numeric format. For target-based (i.e., supervised) training, each set of data (i.e., data of the correlated features of a single composite record) is associated with corresponding ground truth data.

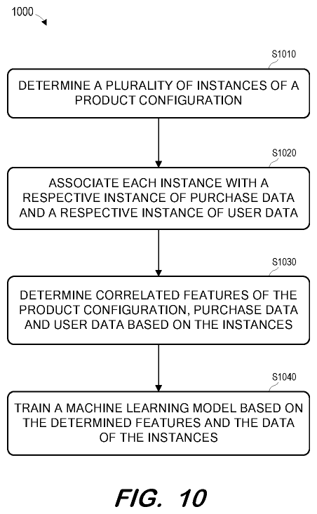

FIG. 10 comprises a flow diagram of process 1000 according to some embodiments. Process 1000 may be performed by architecture 900, but embodiments are not limited thereto. Process 1000 and all other processes mentioned herein may be embodied in program code executable by one or more processing units (e.g., processor, processor core, processor thread) and read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Process 1000 begins at S1010, at which a plurality of instances of a product configuration are determined. The plurality of instances may comprise configurations generated as described above, but embodiments are not limited thereto. In some embodiments, each of the plurality of instances is a sparsely-populated version of a master configuration file.

Next, at S1020, each instance is associated with a respective instance of sales or purchase data and a respective instance of customer or user data. Embodiments are not limited to these two types of instances and may include additional instance types at S1020. The instances may be associated based on common columns. For example, an instance of a product configuration may include a field identifying a particular user (e.g., the user who created the product configuration) and an instance of the user data may also identify the particular user, allowing association of the two instances. The instance of the product configuration may also include a field identifying the particular product (e.g., serial number) and an instance of the purchase data may also identify the particular product, allowing association of all three instances even though the instance of the user data may not include any fields in common with the instance of the product configuration.

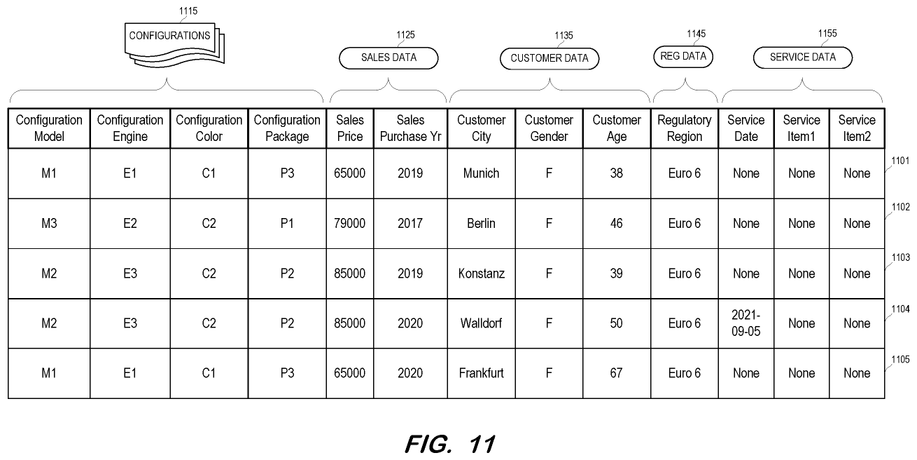

FIG. 11 is a tabular representation of associated data instances according to some embodiments. Each of records 1101-1105 includes data from fields of associated data instances. The associated data instances are various instances of configurations 1115, sales data 1125, customer data 1135, regulatory data 1145 and service data 1155, which may be associated with one another based on common fields as described above.

Correlated features of the various types of data (i.e., product configuration data, purchase data and user data) are determined at S1030. As described above, the correlations may be determined based on a particular field of interest. That is, the features determined at S1030 may be those which are correlated with the field of interest. The correlations are determined based on the data of the instances, e.g., the data of instances 1101-1105.

A machine learning model is trained at S1040 based on the determined features and the data of the instances. Training of the model at S1040 may also comprise creation of training data based on the instances and the determined correlated features. For example, the training data may include each composite record (e.g., instances 1101-1105) but only the fields of such records which are associated with the determined correlated features. By limiting the fields of the training data in this manner, the resulting trained algorithm may be less complex and more accurate than otherwise.

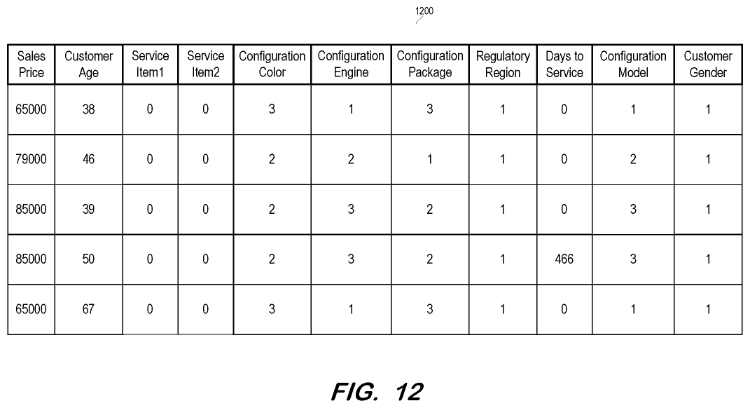

Creation of the training data may also comprise encoding text data of the instances into numerical data which is more efficiently input to and processed by a machine learning model. FIG. 12 illustrates training data 1200 which includes instances corresponding to each of instances 1101-1105. The categorical text data of instances 1101-1105 training system has been converted to numerical data representing each category. Moreover, the feature “Service Date” has been converted to feature “Days to Service” in order to provide semantically meaningful numerals therein. The features “Sales Purchase Yr” and “Customer City” have been omitted because these features were not determined to be correlated features at S1030.

In one example of training of a model, the training data (e.g., a batch of instance data including all features except a target feature) is fed into the model and a loss layer determines a loss based on the resulting output and on ground truth data (e.g., each instance's value of the target feature). The loss is back-propagated to the model to modify the model (i.e., to modify the internal weights of the model) in an attempt to minimize the loss, and the cycle repeats until the loss is satisfactory or training otherwise terminates.

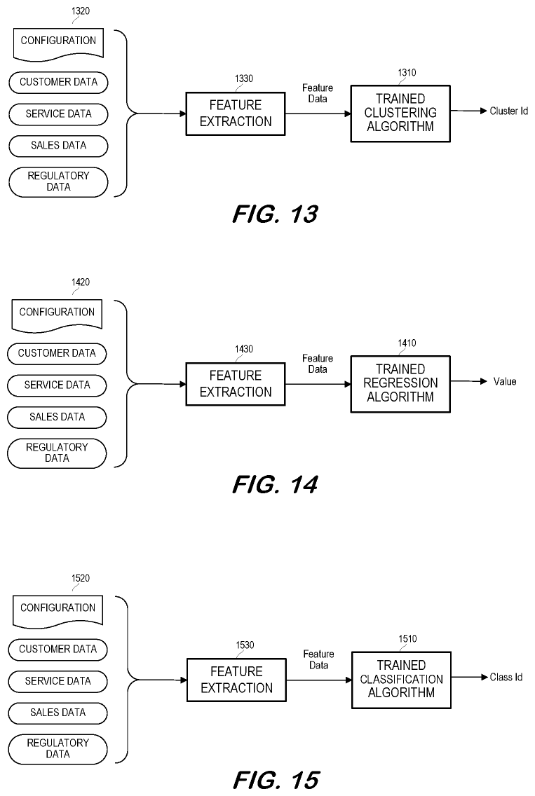

FIG. 13 is a block diagram of an architecture to use a clustering algorithm trained according to some embodiments. In this regard, it will be assumed that clustering algorithm 1310 has been trained as described above to identify a cluster to which a composite data record belongs. The composite record consists of correlated features of various data records 1320 from disparate sources. Data records 1320 include a configuration file as described above and the correlated features are those features which were determined during training of algorithm 1310. Feature extraction component 1330 may operate to receive data records 1320, extract data of the correlated features of data records 1320, encode non-numeric data of the extracted data, and input the resulting data to clustering algorithm 1310. Clustering algorithm 1310 may operate as trained to output a cluster identifier. In some embodiments, the output of clustering algorithm 1310 may consist of likelihoods for each of a plurality of cluster identifiers.

FIG. 14 is a block diagram of an architecture to use a regression algorithm trained according to some embodiments. Regression algorithm 1410 has been trained as described above to determine a value based on a correlated features of data records 1420. Data records 1420 include a configuration file as described above and the correlated features were determined during training of algorithm 1410. Feature extraction component 1430 may operate to receive data records 1420, extract data of the correlated features of data records 1420, encode non-numeric data of the extracted data, and input the resulting data to regression algorithm 1410. Regression algorithm 1410 may operate as trained to output a value based on the input.

FIG. 15 is a block diagram of an architecture to use a classification algorithm trained according to some embodiments. Classification algorithm 1510 has been trained as described above to identify a class based on an input composite data record. The composite record consists of correlated features of various data records 1520, which include a configuration file as described above. Feature extraction component 1530 may operate to receive data records 1520, extract data of the correlated features of data records 1520 which were determined during training of algorithm 1510, encode non-numeric data of the extracted data, and input the resulting data to classification algorithm 1510. Classification algorithm 1510 may operate as trained to output a class identifier. In some embodiments, the output of classification algorithm 1510 may consist of likelihoods for each of a plurality of class identifiers.

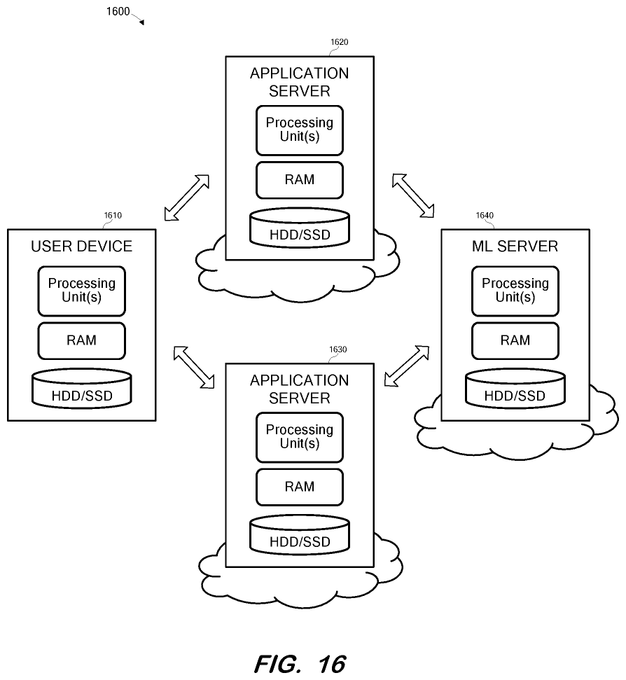

FIG. 16 illustrates cloud-based database deployment 1600 according to some embodiments. In this regard, application server 1620, application server 1630 and machine learning server 1640 may comprise cloud-based compute resources, such as virtual machines, allocated by a public cloud provider providing self-service and immediate provisioning, autoscaling, security, compliance and identity management features.

User device 1610 may issue a request to applications executing on application server 1620 or application server 1630, for example via a Web Browser executing on user device 1610. At least one application may comprise a configuration application to generate sparce configuration files. Machine learning server 1640 may operate to receive data from application servers 1620 and 1630 to determine correlated features of the data, and to trained a machine learning algorithm based on the correlated features. The trained algorithms may be used by application servers 1620, 1630 and/or user device 1610 to infer clusters, values or classes as described herein.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architecture 100 may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A method comprising:
determining a plurality of instances of a configuration;
associating each of the plurality of instances with a first respective record of a first database table and with a second respective record of a second database table to determine a plurality of composite data records;
determining correlated features of the configuration, the first database table and the second database table based on the plurality of composite data records; and
training a machine learning model based on data of the correlated features of the configuration, the first database table and the second database table.

2. A method according to claim 1, wherein each of the plurality of instances is associated with the first respective record of the first database table, the second respective record of the second database table, and a third respective record of the third database table to determine the plurality of composite data records comprises,
wherein determining correlated features comprises determining correlated features of the configuration, the first database table, the second database table and the third database table based on the plurality of composite data records, and
wherein the machine learning model is trained based on data of the correlated features of the configuration, the first database table, the second database table and the third database table.

3. A method according to claim 1, wherein the machine learning model is a clustering model.

4. A method according to claim 1, wherein the machine learning model is a regression model.

5. A method according to claim 1, wherein the machine learning model is a classification model.

6. A system comprising:
a memory storing executable program code; and
a processing unit to execute the program code to cause the system to:
determine a plurality of instances of a master configuration file stored in a first data storage;
associate each of the plurality of instances with a first respective record of a first database table stored in a second data storage and with a second respective record of a second database table stored in a third data storage to determine a plurality of composite data records;
store the plurality of composite data records in the memory;
determine correlated features of the master configuration file, the first database table and the second database table based on the plurality of composite data records stored in the memory; and
train a machine learning model based on data of the correlated features of the master configuration file stored in the first data storage, the first database table stored in the second data storage and the second database table stored in the third data storage.

7. A system according to claim 6, wherein each of the plurality of instances is associated with the first respective record of the first database table, the second respective record of the second database table, and a third respective record of the third database table to determine the plurality of composite data records comprises,
wherein determining correlated features comprises determining correlated features of the master configuration file, the first database table, the second database table and the third database table based on the plurality of composite data records, and
wherein the machine learning model is trained based on data of the correlated features of the master configuration file, the first database table, the second database table and the third database table.

8. A system according to claim 6, wherein the machine learning model is a clustering model.

9. A system according to claim 6, wherein the machine learning model is a regression model.

10. A system according to claim 6, wherein the machine learning model is a classification model.

11. A non-transitory computer-readable medium storing program code executable by one or more processing units to cause a computing system to:
determine a plurality of instances of a master configuration file;
associate each of the plurality of instances with a first respective record of a first database table and with a second respective record of a second database table to determine a plurality of composite data records;
determine correlated features of the master configuration file, the first database table and the second database table based on the plurality of composite data records; and
train a machine learning model based on data of the correlated features of the master configuration file, the first database table and the second database table.

12. A medium according to claim 11, wherein each of the plurality of instances is associated with the first respective record of the first database table, the second respective record of the second database table, and a third respective record of the third database table to determine the plurality of composite data records comprises,
wherein the determination of correlated features comprises determining correlated features of the master configuration file, the first database table, the second database table and the third database table based on the plurality of composite data records, and
wherein the machine learning model is trained based on data of the correlated features of the master configuration file, the first database table, the second database table and the third database table.

13. A medium according to claim 11, wherein the machine learning model is a clustering model.

14. A medium according to claim 11, wherein the machine learning model is a regression model.

15. A medium according to claim 11, wherein the machine learning model is a classification model.
